(19) United States
(12) Patent Application Publication
(10) Pub. No.: US 2007/0147753 A1
(43) Pub. Date: Jun. 28, 2007

(54) Optical fiber and method for fabricating same

(75) Inventors: Seho Park, Gumi-si (KR); Jin-Han Kim, Suseong-gu (KR); Mun-Hyun Do, Chilgok-gun (KR); Sung-Wook Bang, Gumi-si (KR); Yun-Ho Kim, Dong-gu (KR); Jin-Haing Kim, Gumi-si (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 11/516,325

(22) Filed: Sep. 6, 2006

(30) Foreign Application Priority Data
Dec. 27, 2005 (KR) 2005-130825

(51) Int. Cl. G02B 6/02; C03B 37/07; C03B 37/02; C03B 37/025

(52) U.S. Cl. 385/123; 65/384; 65/435

(57) ABSTRACT

Disclosed is a method for fabricating an optical fiber having attenuation loss, in which non-uniformity of the attenuation loss in the lengthwise direction of the optical fiber is equal to or less than 0.05 dB/km in the wavelength band of 1383 nm and an average value of the attenuation loss is equal to or less than 0.35 dB/km. The method comprising the steps of (a) fabricating a soot preform while maintaining an average temperature of a core surface at a level equal to or less than 1000° C. and temperature variation of the core surface according to a growing length of the soot preform in a range of −10 to 10° C./cm, fabricating an optical fiber preform by dehydrating, consolidating and vitrifying the soot preform and (c) drawing the optical fiber from the optical fiber preform under a temperature range between 1900 to 2300° C.

### CLAIM OF PRIORITY

This application claims the benefit of the earlier filing date, under 35 U.S.C. 119(a), to that patent application entitled “Optical Fiber And Method For Fabricating The Same,” filed with the Korean Intellectual Property Office on Dec. 27, 2005 and assigned Ser. No. 2005-130825, the entire contents of which are incorporated herein by reference.

### BACKGROUND OF THE INVENTION

1. Field of the Invention

The present invention relates to optical fiber and a method for fabricating same. More particularly, the present invention relates to optical fiber capable of improving uniformity of attenuation loss and a method for fabricating same.

2. Description of the Related Art

Conventional optical fiber represents high attenuation loss at a wavelength in the order of 1383 nm (nanometers) because of light absorption caused by an “OH” bonding. Thus, the conventional optical fiber is not suitable for optical communication at the wavelength band of 1383 nm. Typically, the wavelength band of 1383 nm includes wavelengths between 1340 nm and 1440 nm. In order to solve the problem occurring in the wavelength band of 1383 nm, low water peak fiber has been suggested. FIG 1a is a graph illustrating attenuation loss measured lengthwise along a low water peak fiber. However, although the low water peak fiber can reduce the attenuation loss derived from the light absorption caused by the “OH” bond, the attenuation loss is unevenly generated in the lengthwise direction of low water peak fiber in the wavelength band of 1383 nm.

Referring to FIG. 1A, the low water peak fiber represents attenuation loss 101 of about 0.35 to 0.37 dB/km at a region of 4.9 to 5 km in the lengthwise direction of the low water peak fiber in the wavelength band of 1383 nm. In addition, average attenuation loss 102 over the whole area of the low water peak fiber is about 0.3 dB/km. Accordingly, when the low water peak fiber is used for a optical communication network in the wavelength band of 1383 nm, attenuation loss is unevenly distributed lengthwise along the low water peak fiber, thereby causing the communication failure or communication error.

### SUMMARY OF THE INVENTION

Accordingly, the present invention has been made to solve the above-mentioned problems occurring in the prior art, and an object of the present invention is to provide optical fiber capable of reducing attenuation loss in a wavelength band of 1383 nm while achieving uniform distribution of attenuation loss in the lengthwise direction thereof.

According to an aspect of the present invention, there is provided an optical fiber, in which non-uniformity of attenuation loss in a lengthwise direction of the optical fiber is equal to or less than 0.05 dB/km in a wavelength band of 1383 nm and an average value of the attenuation loss is equal to or less than 0.35 dB/km.

According to another aspect of the present invention, there is provided a method for fabricating an optical fiber. The method comprising the steps of (a) fabricating a soot preform while maintaining an average temperature of a core surface at a level equal to or less than 1000° C. and temperature variation of the core surface according to a growing length of the soot preform in a range of −10 to 10° C./cm, (b) fabricating an optical fiber preform by dehydrating, consolidating and vitrifying the soot preform, and (c) drawing the optical fiber from the optical fiber preform under a temperature range between 1900 to 2300° C.

### BRIEF DESCRIPTION OF THE DRAWINGS

The above features and advantages of the present invention will be more apparent from the following detailed description taken in conjunction with the accompanying drawings, in which:

FIG. 1A is a graph illustrating the relationship between regional attenuation loss and average attenuation loss;

FIG. 1B is a graph illustrating the difference of regional attenuation loss obtained from the relationship between regional attenuation loss and average attenuation loss shown in FIG. 1a;

FIG. 2 is a graph illustrating the wave style non-straight line (P_{wave});

FIG. 3 is a graph illustrating the step style non-straight line;

FIGS. 4A and 4B are graphs illustrating regional attenuation loss of optical fiber fabricated according to the present invention in a wavelength band of 1383 nm;

FIG. 5 is a graph illustrating the wave style non-straight line of optical fiber according to the present invention;

FIG. 6 is a view illustrating an apparatus and a method for fabricating a soot preform through vapor-phase axial deposition;

FIG. 7 is a view illustrating an apparatus and a method for fabricating a soot preform through outside vapor-phase axial deposition;

FIGS. 8A and 8B are graphs illustrating the surface temperature of a core of a soot preform measured along the length of the core of the soot preform, which is grown through vapor-phase axial deposition; and

FIG. 9 is a view illustrating the procedure of sintering and vitrifying a soot preform in the lengthwise direction of the soot preform through a zone sintering method.

### DETAILED DESCRIPTION OF THE INVENTION

Hereinafter, embodiments of the present invention will be described with reference to the accompanying drawings. For the purposes of clarity and simplicity, a detailed description of known functions and configurations incorporated herein will be omitted as it may make the subject matter of the present invention unclear.

The present invention relates to optical fiber used for optical communication in a wavelength band of 1383 nm and a method for fabricating same. The optical fiber according to the present invention represents uniform attenuation loss characteristics in the lengthwise direction thereof in a wavelength band of 1383 nm.

Such uniform attenuation loss in the lengthwise direction of the optical fiber can be detected by measuring non-uniformity parameters through attenuation loss measurement using optical time domain reflection (OTDR).

The non-uniformity parameters include the difference of regional attenuation loss, wave style non-straight line (P_{wave}), step style non-straight line (Pₛₜₑₚ), etc. The above non-uniformity parameters and OTDR are defined in international standards such as IEC-TR62033 and ICE-TR62316.

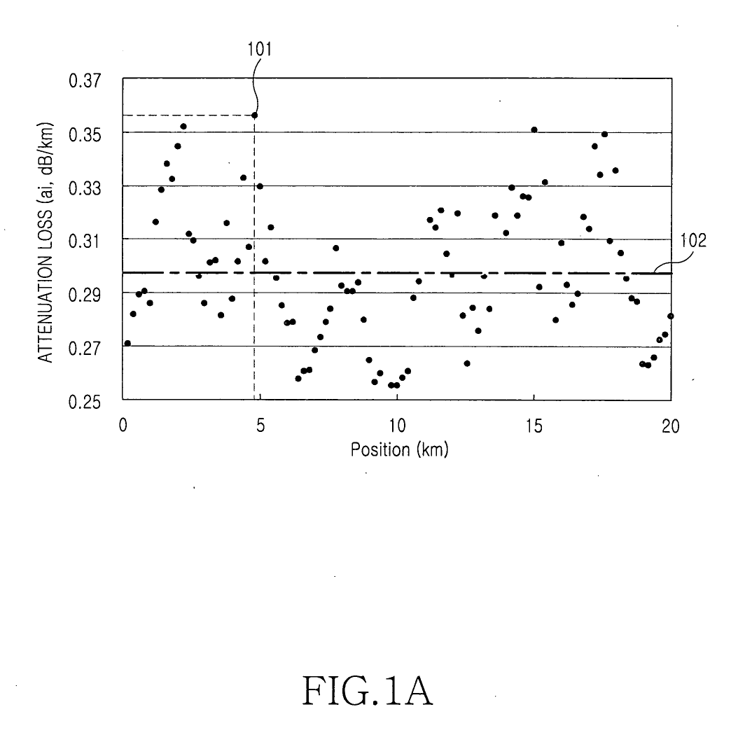

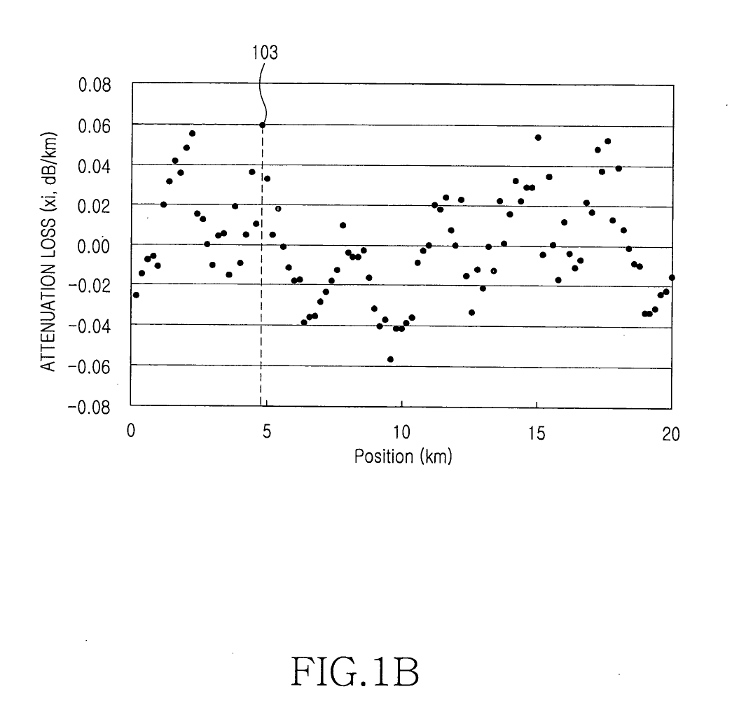

FIG. 1B is a graph illustrating the difference of regional attenuation loss obtained from the relationship between regional attenuation loss and average attenuation loss shown in FIG. 1A. The difference of regional attenuation loss 103 refers to the difference between attenuation loss 101 and an average attenuation loss at a predetermined region.

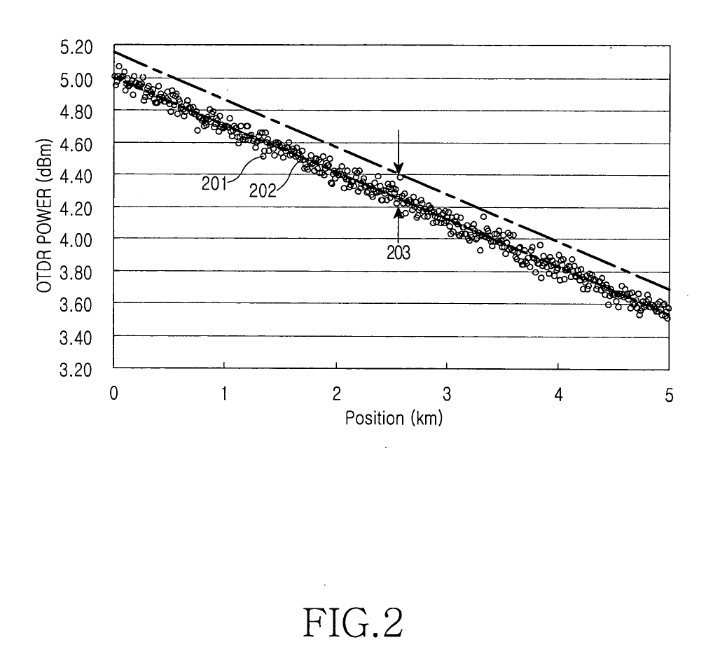

FIG. 2 is a graph illustrating the wave style non-straight line (P_{wave}), which is defined as a differential value 203 between a base trend line 202 obtained through least square approximation and an OTDR power signature 201.

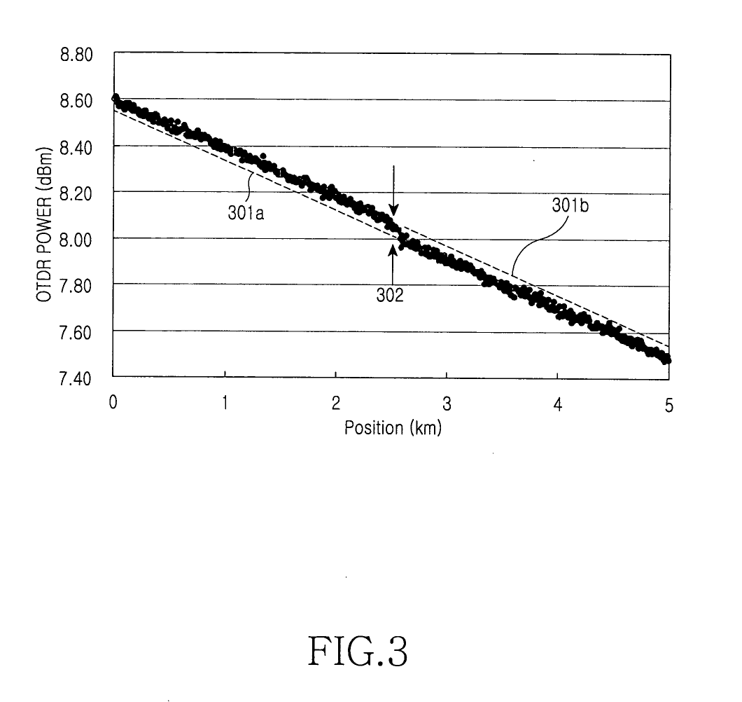

FIG. 3 is a graph illustrating the step style non-straight line. The step style non-straight line is defined as a differential value 302 between trend lines 301a and 301b formed between two adjacent OTDR measurement points.

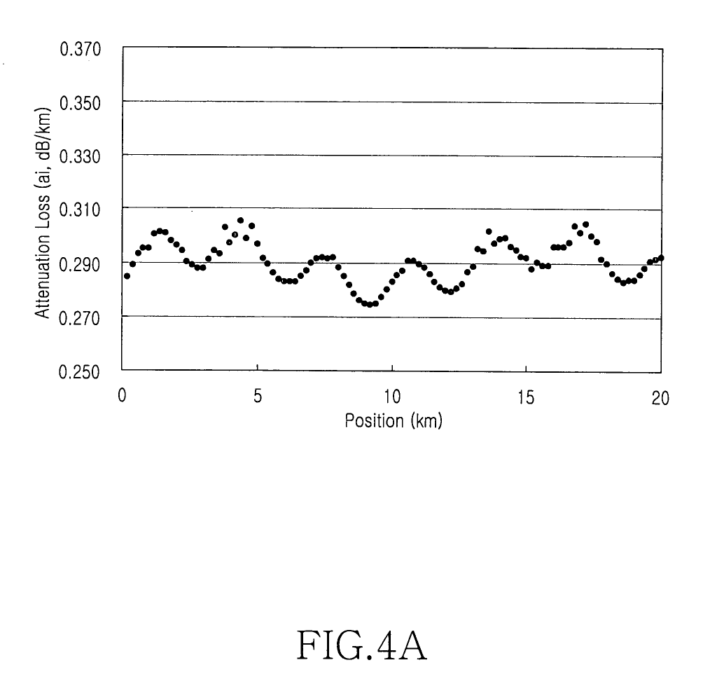

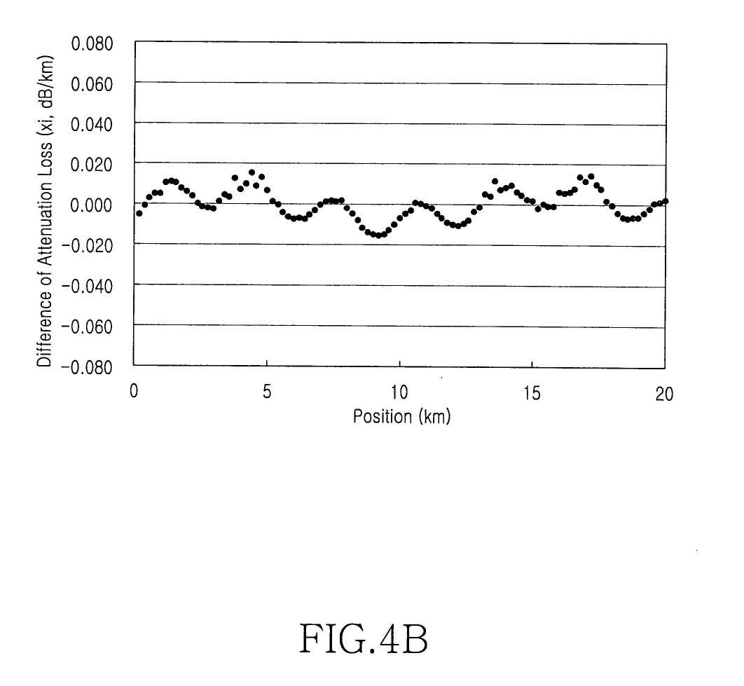

FIGS. 4A and 4B are graphs illustrating regional attenuation loss of optical fiber fabricated according to the present invention, in which the difference of regional attenuation loss is reduced to a level equal to or less than 0.02 dB/km in the wavelength band in the order of 1383 nm.

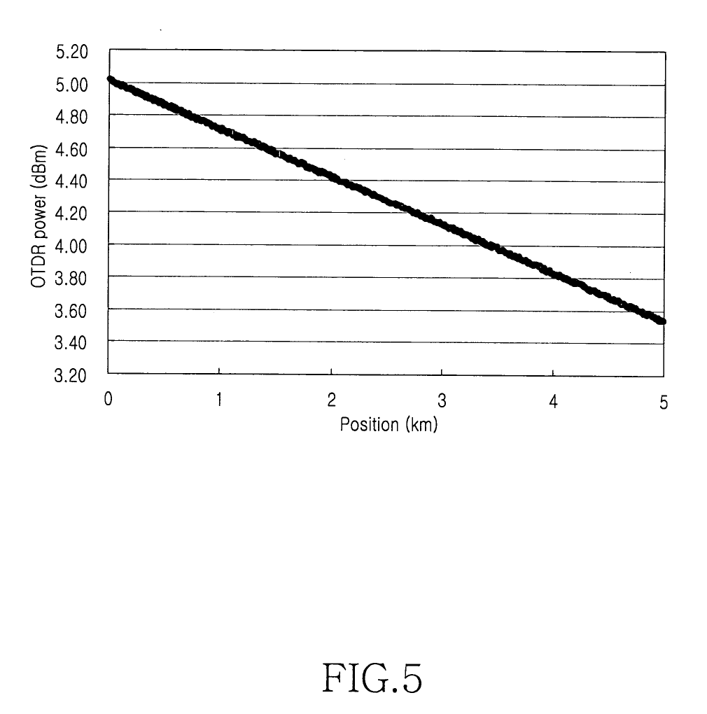

FIG. 5 is a graph illustrating the wave style non-straight line of optical fiber according to the present invention, in which attenuation loss of the wave style non-straight line is reduced to a level equal to or less than 0.03 dB/km in the wavelength band of 1383 nm. Referring to FIG. 5, attenuation loss of the step style non-straight line of the optical fiber according to the present invention is reduced to a level equal to or less than 0.01 dB/km in the wavelength band of 1383 nm.

According to an embodiment of the present invention, the optical fiber is fabricated through the steps of (a) fabricating a soot preform by depositing soot while maintaining an average temperature of a core surface at a level equal to or less than 1000° C. and temperature variation (dT/dz) of the core surface according to a growing length of the soot preform in a range of −10 to 10° C./cm, (b) fabricating an optical fiber preform by dehydrating, consolidating and vitrifying the soot preform, and (c) drawing the optical fiber from the optical fiber preform under the temperature between 1900 to 2300° C.

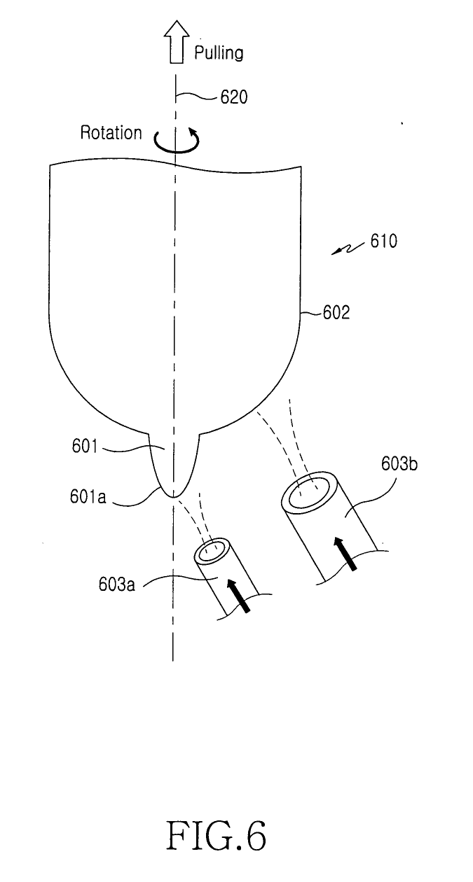

FIG. 6 is a view illustrating an apparatus for fabricating the soot preform through vapor-phase axial deposition. Referring to FIG. 6, the soot preform 610 includes a starting rod made of glass and aligned on a vertical axis 620 so as to provide a base for growing the soot preform 610, a core 601 formed by depositing soot at an end of the starting rod, and a clad 602. The core 601 has a relatively higher refractive index and the clad 602 surrounding the core 601 has a relatively lower refractive index. While depositing the soot, the soot preform 610 rotates and moves upward at a predetermined speed. At this time, the soot preform 610 is rotated about the vertical axis 620, so that the soot preform 610 has rotational symmetry. In addition, since the soot preform 610 moves upwards along the vertical axis 620, the soot preform 610 continuously grows downward along the vertical axis 620.

Source materials including SiCl₄ for forming glass and GeCl₄ for controlling the refractive index, fuel gas (G_{F}) consisting of hydrogen, and oxidation gas (G_{O}) consisting of oxygen are fed into a first torch 603. Selectively, one of POCl₃ and BCl₃ can be used as a material for controlling the refractive index.

The first torch 603a has a central axis, which is inclined while forming an acute angle with respect to the vertical axis 620, and sprays soot consisting of GeO₂ and SiO₂ and being created by means of flame directed toward an end portion of the soot preform 610, so that the core 601 grows downward from the end portion of the soot preform 610. That is, the soot created by the first torch 603a is deposited on a core surface 601a while moving along the flame.

If the average temperature on the surface of the soot preform exceeds 1000° C., a portion of GeO₂ contained in the soot may be reduced to GeO. Such GeO has an unstable covalent bonding structure, so that it may cause a fault to a glass network structure. Such a fault of the glass network structure may also increase the possibility of “OH” bonding. In addition, non-uniform distribution of the glass network structure including GeO may cause non-uniform “OH” attenuation loss in the lengthwise direction. Therefore, it is necessary to control the intensity of flame, the position and the angle of the first torch 603a in such a manner that the average temperature on the surface of the soot preform does not exceed 1000° C.

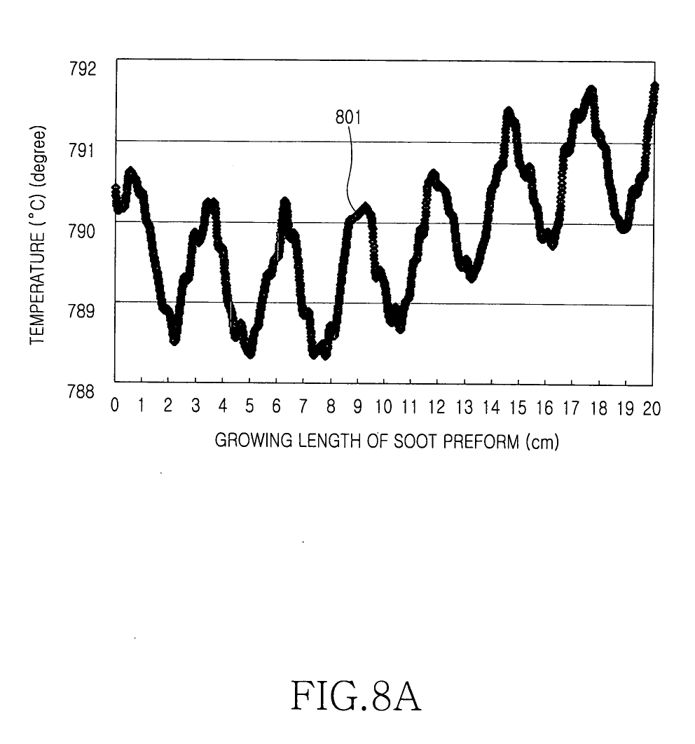

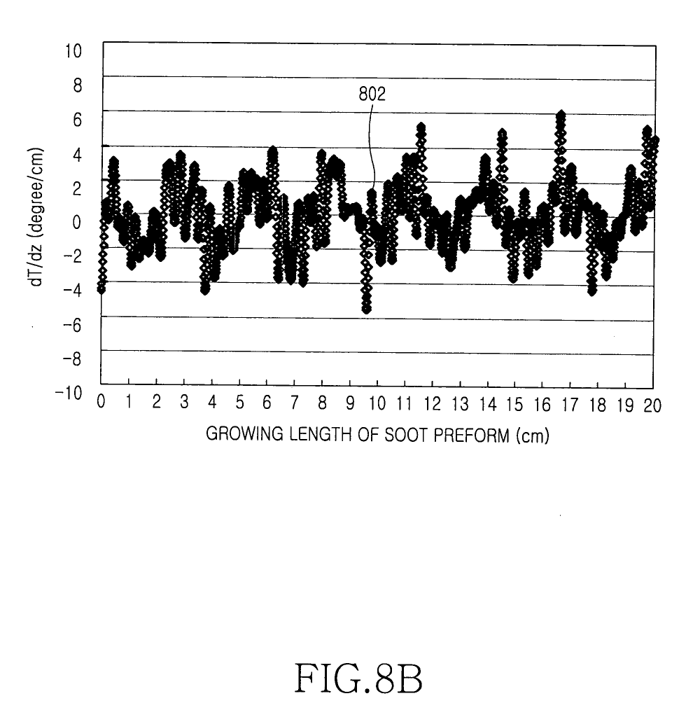

FIGS. 8A and 8B are graphs illustrating the temperature (° C.) as a function of the growing length (cm), in which an x-axis represents the growing length and a y-axis represents the temperature. FIG. 8B shows temperature variation (dT/dz) 802 of the core surface 601a as a function of the growing length of the soot preform. Preferably, soot is deposited while maintaining the temperature variation (dT/dz) 802 of the core surface 601a in a range of −10 to 10° C./cm. In addition, as shown in FIG. 8A, it is preferred to maintain the average temperature of the core surface 601a in a range of 700 to 850° C. In FIG. 8B, “z” refers to the growing length of the soot preform, which is grown through vapor phase axial deposition, and “T” refers to the surface temperature of core soot.

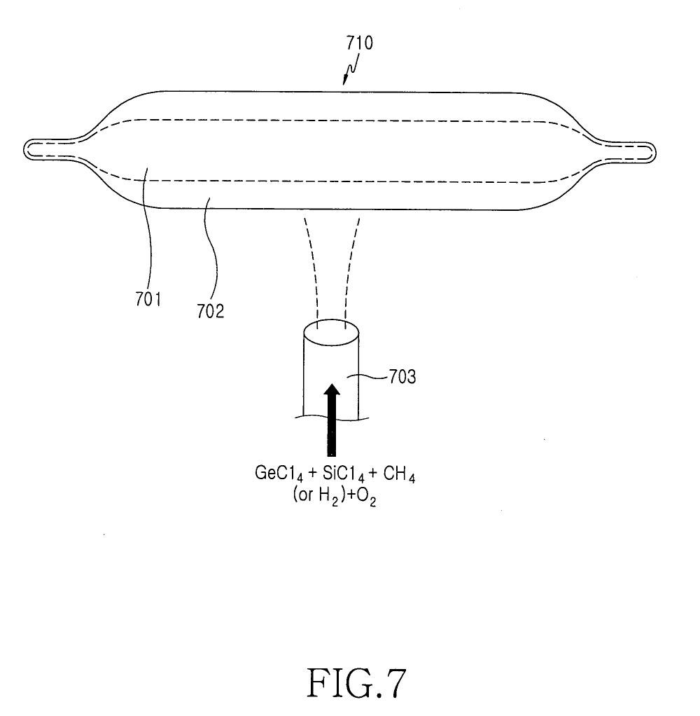

In addition to vapor phase axial deposition, as shown in FIG. 7, outside vapor phase deposition can be employed in order to fabricate the soot preform. Referring to FIG. 7, a soot preform 710 includes a core 701 and a clad 702, in which the core 701 consists of GeO₂ and SiO₂ and the clad 702 consists of SiO₂. In order to allow the clad 702 to have a relatively lower refractive index as compared with that of the core 701, materials including SiCl(4−2ₓ)Oₓ or SiF(4−2ₓ)Oₓ can further be added to the clad 702. Herein, “x” refers to 0 or 1.

The apparatus for fabricating the soot preform shown in FIG. 7 includes a burner into which SiCl₄, GeCl₄, fuel and oxygen gas are fed. In addition, the burner heats SiCl₄ and GeCl₄ at the high temperature such that they react with oxygen, thereby forming soot consisting of GeO₂ and SiO₂. The soot is deposited while moving along the flame of the burner, thereby sequentially forming the core and the clad of the soot preform. Preferably, when the core soot is deposited in order to form the soot preform, the average temperature of the core surface is maintained at a level equal to or less than 1000° C. and standard deviation of the temperature on the core surface is equal to or less than 10° C. in the lengthwise direction of the core surface.

The soot preform 610 fabricated according to the embodiment of the present invention is processed into an optical fiber preform by sequentially performing dehydrating, consolidating and vitrifying processes.

The dehydrating process for the soot preform 610 is conducted under the inert gas atmosphere including Cl₂ while maintaining the average temperature of the soot preform 610 in a range of 900 to 1300° C. Attenuation loss, which occurs in the wavelength band of 1383 nm due to light absorption caused by the “OH” bonding, is reduced proportionally to the density of Cl₂ and dehydration time. During the dehydration process, the density of oxygen remaining in the inert gas including helium (He) must be less than 30 ppm. Thus, 0.3 to 10 volume percent of Cl₂ is added to the inert gas, and the total dehydration time is within a range of 12 minutes to 6 hours. Preferably, the average temperature of the soot preform is maintained in a range of 1050 to 1200° C. during the dehydration process.

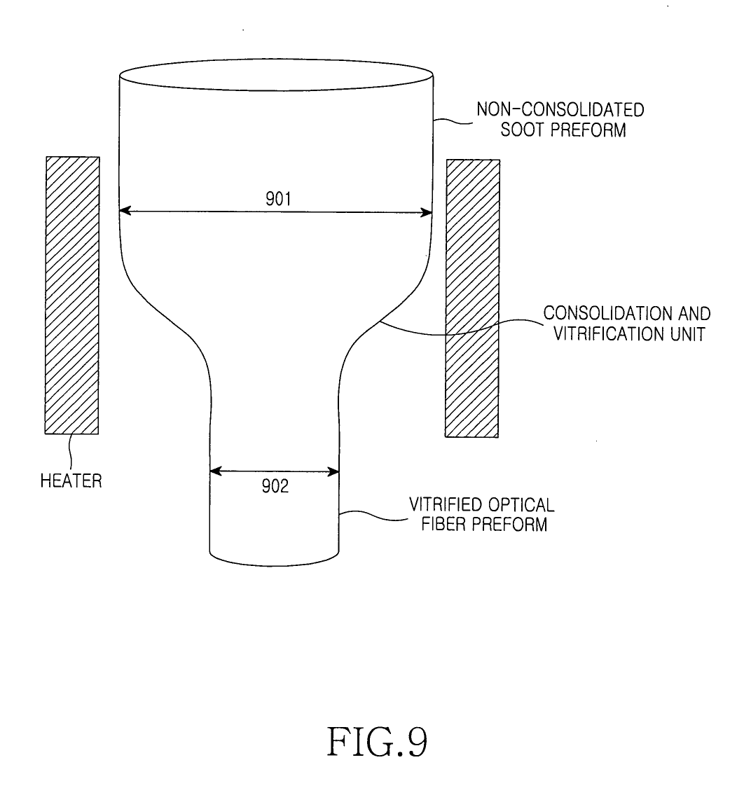

FIG. 9 is a view illustrating the procedure of sintering and vitrifying a soot preform in the lengthwise direction of the soot preform through a zone sintering method. Referring to FIG. 9, the number of core pores causing the step style non-straight line is reduced as the consolidation velocity decreases. Therefore, it is preferred to perform the zone sintering method at a low consolidation velocity in order to reduce the step style non-straight line. When sintering the soot preform using the zone sintering method, the consolidation velocity is preferably set to a level equal to or lower than 1/10^{th} diameter (901) of the soot preform/min. Preferably, the level is set equal to or lower than 1/20^{th} the diameter (901) of the soot preform/min. That is, if the diameter of the soot preform is 200 mm, the consolidation velocity is preferably set to a level equal to or lower than 20 mm/min,and preferably, to a level equal to or lower than 10 mm/min. Referring to FIG. 5, if the consolidation velocity is set to a level equal to or lower than 1/20^{th} the diameter of the soot preform/min, the step style non-straight line of optical fiber is less than 0.01 dB. Returning to the apparatus shown in FIG. 3, if the consolidation velocity is set higher than ⅕^{th} the diameter of the soot preform/min, the step style non-straight line of optical fiber exceeds 0.06 dB.

In addition to the zone sintering method, a full sintering method can be employed in order to sinter the soot preform. According to the full sintering method, heat is uniformly applied over the whole area of the soot preform, thereby sintering the whole area of the soot preform in the lengthwise direction thereof. In this case, in order to minimize the number of closed pores, the sintering process is performed under the vacuum atmosphere of about 10 torr or less while maintaining the average temperature of the soot preform in a range of 1100 to 1500° C. and standard deviation of the temperature on the soot preform at a level equal to or less than 10° C. in the lengthwise direction of the soot preform.

In the optical fiber preform fabricated through the above procedure, a ratio of the clad to the core is equal to or more than 3.5, preferably, equal to or more than 4. More preferably, the diameter of the clad of the optical preform is 20 mm, which is at least four times larger than that of the core. In order to satisfy the single mode condition, a secondary clad layer can be added to an outer surface of the optical fiber preform, which serves as a primary preform, such that the diameter of the clad is at least twelve times larger than that of the core. Various schemes, such as outside vapor-phase deposition, plasma outside vapor-phase deposition, or over-jacketing in which heat is applied to a quartz tube formed on the primary preform, can be utilized in order to fabricate a secondary optical fiber preform by adding the secondary clad layer to the outer surface of the primary preform. When fabricating the primary preform, it is preferred to design the clad to have a diameter, which is at least four times larger than that of the core.

Optical fiber is drawn from the optical fiber preform fabricated through the above procedure by melting and drawing the end portion of the optical fiber preform under the temperature range of 1900 to 2300° C. When drawing the optical fiber, the standard deviation for the outer diameter of the optical fiber is preferably maintained at a level equal to or less than 0.8 μm. More preferably, the standard deviation for the outer diameter of the optical fiber is maintained at a level equal to or less than 0.2 μm. That is, it is preferably that the standard deviation for the outer diameter of the optical fiber is maintained as low as possible. When the standard deviation for the outer diameter of the optical fiber becomes high, variation of the mode filed diameter may increase in the lengthwise direction of the optical fiber, thereby causing non-uniform attenuation loss.

The present invention minimizes attenuation loss occurring in the wavelength band of 1383 nm due to light absorption caused by “OH” bonding and non-uniformity of attenuation loss in the lengthwise direction of the optical fiber, thereby providing an optical fiber suitable for optical communication at the wavelength band of 1383 nm. Accordingly, the optical fiber according to the present invention can be preferably used in a wavelength range of 1310 nm to 1625 nm.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An optical fiber, in which non-uniformity of attenuation loss in a lengthwise direction of the optical fiber is equal to or less than 0.05 dB/km at a wavelength band of 1383 nm and an average value of the attenuation loss is equal to or less than 0.35 dB/km.

2. The optical fiber as claimed in claim 1, wherein the non-uniformity of attenuation loss of the optical fiber includes a difference between regional attenuation loss and average attenuation loss of the optical fiber at a predetermined region in a lengthwise direction of the optical fiber.

3. The optical fiber as claimed in claim 1, wherein the non-uniformity in a lengthwise direction of the optical fiber includes a wave style non-straight line.

4. The optical fiber as claimed in claim 1, wherein the non-uniformity in a lengthwise direction of the optical fiber includes a step style non-straight line.

5. An optical fiber, in which non-uniformity of attenuation loss in a lengthwise direction of the optical fiber is equal to or less than 0.10 dB/km at a wavelength band of 1383 nm, an average value of the attenuation loss is equal to or less than 0.35 dB/km, a chromatic dispersion coefficient is in a range of 1.5 to 8.0 ps/nmkm, a maximum single mode cutoff wavelength is 1340 nm, and a maximum polarization mode dispersion is 0.20 ps/nmkm^{1/2} at a wavelength band of 1383 nm.

6. A method for fabricating an optical fiber, the method comprising the steps of:
(a) fabricating a soot preform while maintaining an average temperature of a core surface at a level equal to or less than 1000° C. and temperature variation of the core surface according to a growing length of the soot preform in a range of −10 to 10° C./cm;
(b) fabricating an optical fiber preform by dehydrating, consolidating and vitrifying the soot preform; and
(c) drawing the optical fiber from the optical fiber preform under a temperature range between 1900 to 2300° C.

7. The method as claimed in claim 6, wherein, in step (b), the soot preform is dehydrated for 12 minutes to 6 hours under an inert gas atmosphere including 0.3 to 10 volume percent of Cl₂ while maintaining an average temperature of the soot preform in a range of 900 to 1300° C., in which He is used as inert gas and density of oxygen is maintained at a level less than 30 ppm.

8. The method as claimed in claim 6, wherein, in step (b), the soot preform is consolidated and vitrified while maintaining a consolidation velocity at a level equal to or lower than 1/10^{th} the diameter of the soot preform/min.

9. The method as claimed in claim 6, wherein, in step (b), the soot preform is consolidated and vitrified under a vacuum atmosphere of about 10 torr or less by uniformly applying heat over a whole area of the soot preform such that the whole area of the soot preform is simultaneously sintered in a lengthwise direction thereof while maintaining an average temperature of the soot preform in a range of 1100 to 1500° C. and the standard deviation of a temperature on the soot preform at a level equal to or less than 10° C. in the lengthwise direction of the soot preform.

10. A method for fabricating an optical fiber, the method comprising the steps of:
(a) fabricating a soot preform while maintaining an average temperature of a core surface at a level equal to or less than 1000° C./cm and the standard deviation of a temperature on the core surface at a level equal to or less than 10° C. in a lengthwise direction of the core surface;
(b) fabricating an optical fiber preform by dehydrating, consolidating and vitrifying the soot preform; and
(c) drawing the optical fiber from the optical fiber preform under a temperature range between 1900 to 2300° C.
